(19) United States
(12) Patent Application Publication
(10) Pub. No.: US 2017/0167743 A1
(43) Pub. Date: Jun. 15, 2017

(54) SYSTEM AND METHOD TO REDUCE PARTICULATE POLLUTANTS IN A CONDITIONED SPACE

(71) Applicant: Carrier Corporation, Palm Beach Gardens, FL (US)

(72) Inventors: Daniel J. Dempsey, Carmel, IN (US); Robert W. Peitz, JR., Fishers, IN (US); Brent Kumfer, Carmel, IN (US)

(21) Appl. No.: 15/379,170

(22) Filed: Dec. 14, 2016

Related U.S. Application Data
(60) Provisional application No. 62/266,986, filed on Dec. 14, 2015.

(51) Int. Cl. F24F 11/00; G05B 19/048; F24F 3/16

(52) U.S. Cl. CPC F24F 11/0017; F24F 11/0079; F24F 3/1603; G05B 19/048; F24F 2011/0023; F24F 2011/0019; F24F 2011/0058; F24F 2011/0071; F24F 2003/1642; G05B 2219/2614

(57) ABSTRACT

A system and method to reduce particulate pollutants in a conditioned space using an indoor HVAC unit in communication with a system controller, the system controller configured to receive at least one of an outside air particulate forecast and an access signal from a secondary source, determine at least one of whether the outside air particulate forecast is greater than or equal to a particulate limit whether an access duration value is greater than or equal to opening duration limit; and whether an access occurrence value is greater than or equal to opening occurrence limit, and to operate an indoor HVAC unit based in part on at least one of the outside air particulate forecast and the access signal.

### CROSS-REFERENCE TO RELATED APPLICATIONS

The present application is a nonprovisional patent application, which claims priority to U.S. Patent Application Ser. No. 62/266,986, filed Dec. 14, 2016, which is herein incorporated in its entirety.

### TECHNICAL FIELD OF THE DISCLOSED EMBODIMENTS

The presently disclosed embodiments generally relate to heating, ventilation, and air conditioning systems, and more particularly, to a system and method to reduce particulate pollutants in a conditioned space.

### BACKGROUND OF THE DISCLOSED EMBODIMENTS

A significant number of people suffer from hay fever as a result of the number of particulate pollutants present in the outside air. Generally, pollens, mold, dust, and outdoor air pollutants commonly cause many to suffer allergic reactions. In order to remove allergens within the home, the homeowner typically has to manually activate an air filtration system. In instances where the home has a ventilation system, the ingestion of outside air may increase the particulate levels inside the home.

Accordingly, there exists a need for a system and method to reduce particulate pollutants within the home without manual intervention from the homeowner.

### SUMMARY OF THE DISCLOSED EMBODIMENTS

In one aspect, an HVAC system is provided. The HVAC system includes at least one secondary source, a system controller in communication with the secondary source an HVAC unit in communication with the system controller, the HVAC unit comprising a fan assembly configured to condition air within an interior space. The system controller is configured to receive at least one of an outside air particulate forecast and an access signal from the secondary source and transmit a signal to operate the fan assembly based on at least one of the outside air particulate forecast and access signal. In an embodiment, the HVAC system further includes a filtering device in airflow communication with the HVAC unit, the filtering device configured to filter the air within an interior space

In an embodiment, the at least one secondary source includes a website. In an embodiment, the website is configured to supply up to date, but not necessarily instantaneous, outside air particulate forecast. In an embodiment, the outside air particulate forecast includes airborne pollen levels.

In an embodiment, the system controller is further configured to determine whether the outside air particulate forecast is greater than or equal to a particulate limit, and transmit a signal to turn on a fan assembly if the outside air particulate forecast is greater than or equal to a particulate limit. In one embodiment, the particulate limit is adjustable.

In an embodiment, the at least one secondary source includes at least one sensing device configured to transmit the access signal. In one embodiment, the system controller is further configured to generate an access duration value based in part on the access signal, generate an access occurrence value based in part on the access signal, determine whether the access occurrence value is greater than or equal to an opening duration limit, transmit a signal to turn on a fan assembly if the outside air particulate forecast is greater than or equal to a particulate limit and either the access duration value is greater than or equal to the opening duration limit, or if the access occurrence value is greater than or equal to the opening occurrence limit. In an embodiment, the opening duration limit and the opening occurrence limit are adjustable.

In any of the preceding embodiments, the HVAC system further includes a ventilation device in air flow communication with the HVAC unit, wherein the ventilation device is configured to facilitate distribution of fresh air throughout an interior space. In an embodiment, the system controller is further configured to transmit a signal to operate the ventilation device based on at least one of the outside air particulate forecast and the access signal.

In an embodiment, the system controller is further configured to transmit a signal to turn off the ventilation device if the outside air particulate forecast is greater than or equal to a particulate limit. In an embodiment, the system controller is further configured to transmit a signal to turn off the ventilation device if the outside air particulate forecast is greater than or equal to a particulate limit and either the access duration value is greater than or equal to the opening duration limit, or the access occurrence value is greater than or equal to the opening occurrence limit.

In one aspect, a method of reducing particulate pollutants within a conditioned space using a system controller is provided. The method includes operating the system controller to receive at least one of an outside air particulate forecast and an access signal from at least one secondary source, and operating the system controller to determine at least one of: whether the outside air particulate forecast is greater than or equal to a particulate limit, whether an access duration value is greater than or equal to opening duration limit, and whether an access occurrence value is greater than or equal to opening occurrence limit; and operating the system controller to operate a fan assembly of an HVAC unit based in part on at least one of the outside air particulate forecast and the access signal. In an embodiment the secondary source comprises at least one of a website and at least one sensing device. In an embodiment the outside air particulate forecast comprises airborne pollen levels.

In an embodiment, the method further includes operating the system controller to generate an access duration value based in part on the access signal, and operating the system controller to generate an access occurrence value based in part on the access signal.

In an embodiment, the method includes operating the system controller to transmit a signal to turn on a fan assembly if the outside air particulate forecast is greater than or equal to the particulate limit. In an embodiment, the method includes operating the system controller to transmit a signal to turn on a fan assembly if the outside air particulate forecast is greater than or equal to the particulate limit and either the access duration value is greater than or equal to opening duration limit, or access occurrence value is greater than or equal to opening occurrence limit.

In an embodiment, the method further includes operating the system controller to operate a ventilation device based in part on at least one of the outside air particulate forecast and the access signal. In an embodiment, the method includes operating the system controller to turn off the ventilation device if the outside air particulate forecast is greater than or equal to the particulate limit. In an embodiment, the method includes operating the system controller to turn off the ventilation device if the outside air particulate forecast is greater than or equal to the particulate limit and either the access duration value is greater than or equal to opening duration limit, or access occurrence value is greater than or equal to opening occurrence limit.

In one aspect, a method of reducing particulate pollutants within a conditioned space using a system controller. The method includes operating the system controller to receive an outside air particulate forecast from a secondary source, operating the system controller to determine whether the outside air particulate forecast is greater than or equal to a particulate limit, and operating the system controller to operate a fan assembly of an HVAC unit based in part on the outside air particulate forecast.

In an embodiment, the method includes operating the system controller to operate a ventilation device based in part on the outside air particulate forecast. In an embodiment, the method includes operating the system controller to turn off the ventilation device if the outside air particulate forecast is greater than or equal to the particulate limit.

In one aspect, a method of reducing particulate pollutants within a conditioned space using a system controller. The method includes operating the system controller to receive an access signal from at least one sensing device, operating the system controller to determine at least one of: whether an access duration value is greater than or equal to opening duration limit and whether an access occurrence value is greater than or equal to opening occurrence limit; and operating the system controller to operate a fan assembly of an HVAC unit based in part on the access signal.

In an embodiment, the method includes operating the system controller to generate an access duration value based in part on the access signal, and operating the system controller to generate an access occurrence value based in part on the access signal. In an embodiment, the method includes operating the system controller to transmit a signal to turn on a fan assembly if either the access duration value is greater than or equal to an opening duration limit or if the access occurrence value is greater than or equal to an opening occurrence limit.

In an embodiment, the method includes operating the system controller to operate a ventilation device based in part on the access signal. In an embodiment, the method includes operating the system controller to turn off the ventilation device if either the access duration value is greater than or equal to opening duration limit, or access occurrence value is greater than or equal to opening occurrence limit.

### BRIEF DESCRIPTION OF DRAWINGS

FIG. 1A illustrates a schematic diagram of a HVAC system according to an embodiment of the present disclosure;

FIG. 1B illustrates a schematic diagram of a HVAC system according to another embodiment of the present disclosure;

FIG. 1C illustrates a schematic diagram of a HVAC system according to another embodiment of the present disclosure; and

FIG. 2 illustrates a schematic flow diagram of a method for reducing particulate pollutants in a conditioned space according to one embodiment of the present disclosure; and

FIG. 3 illustrates a schematic flow diagram of a method for reducing particulate pollutants in a conditioned space according to another embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

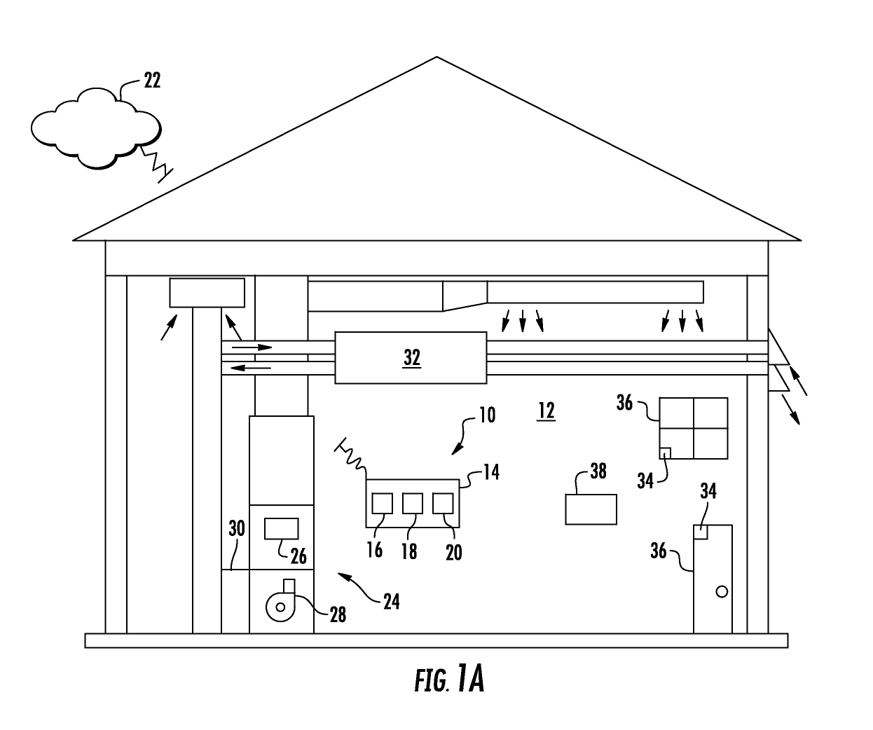

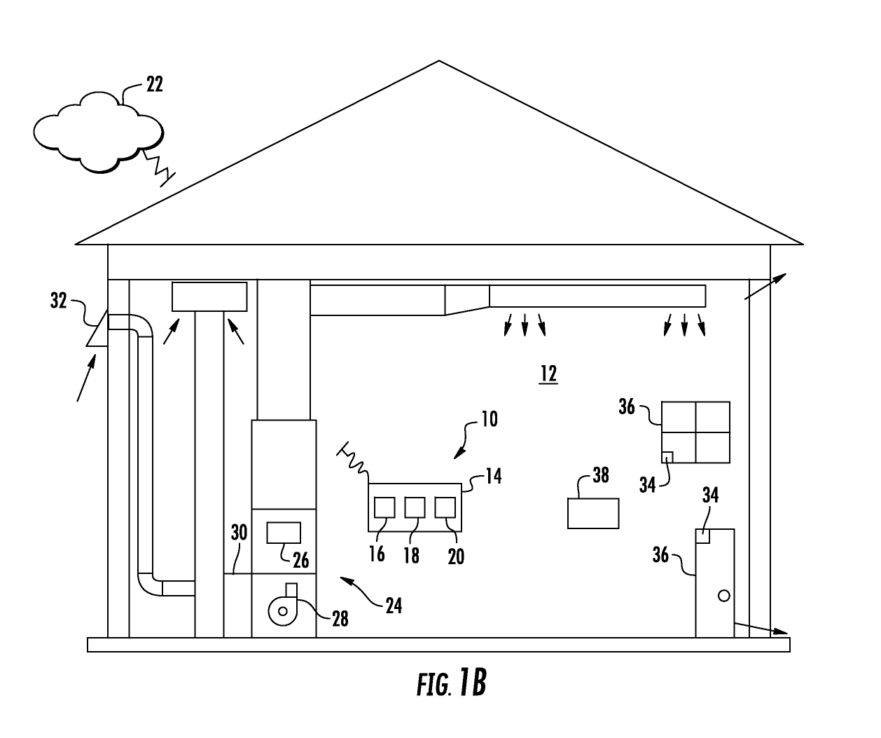

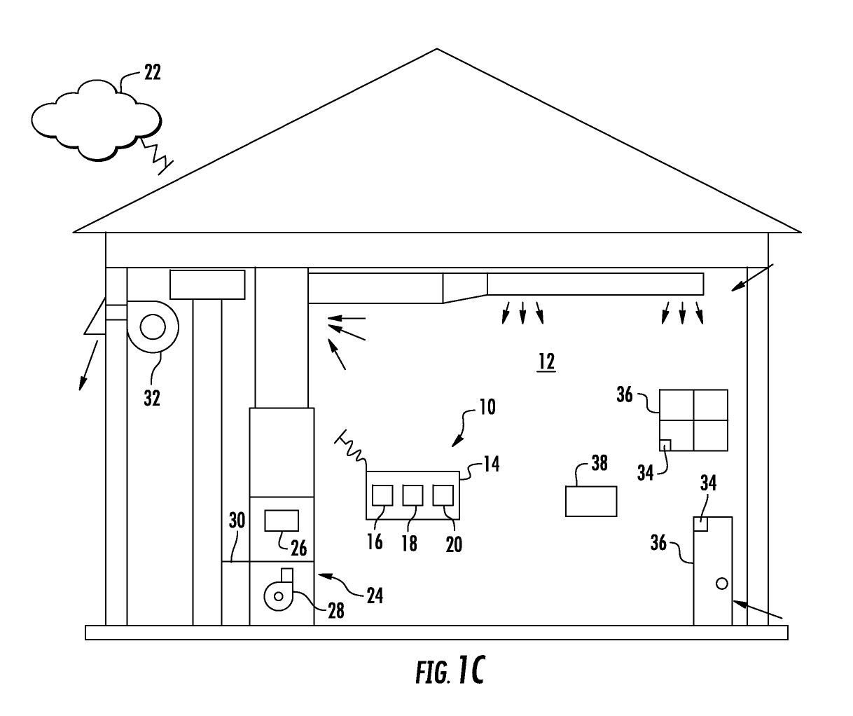

FIGS. 1A-1C schematically illustrate embodiments of an HVAC system, generally indicated at 10, configured to condition air within an interior space 12. The HVAC system 10 includes a system controller 14 including a processor 16 in communication with a memory 18, and a communication module 20. In an embodiment, the system controller 14 includes a thermostat. The communication module 20 is configured to communicate with a secondary source (not shown) via a wired or wireless connection to a network 22, for example the Internet.

In one embodiment, the secondary source is configured to supply up to date, but not necessarily instantaneous, outside air particulate forecast. The particulate information may include measures such as pollen count, PM2.5, PM10, air quality index, or any other known measurement of air quality, to name a few non-limiting examples. It will be appreciated that the secondary source may include a website, or a live feed, or any other source capable of supplying up to date, but not necessarily instantaneous, outside air particulate forecast to name a few of non-limiting examples. It will further be appreciated that the memory 16 may also be external to the system controller 12, for example, on an external server.

The HVAC system 10 further includes an HVAC unit 24 in communication with the system controller 14. In the illustrated, non-limiting embodiment, the HVAC unit 24 is a fan coil containing an indoor controller 26 in communication with a fan assembly 28. It will be appreciated that the HVAC unit 24 may also include a furnace and evaporator coil combination, and a geothermal heat pump to name a couple of non-limiting example. In an embodiment, the HVAC system 10 further includes a filtration device 30 in airflow communication with the HVAC unit 24. The filtration device 30 is configured to filter the air within the interior space 12 and optionally filter the fresh air entering from the outside.

In an embodiment, the HVAC system 10 further includes a ventilation device 32. In some embodiments, the ventilation device 32 is in airflow communication with the HVAC unit 24 (as shown in FIGS. 1A and 1B) and in electrical communication with the system controller 14. The ventilation device 32 is configured to facilitate proper distribution of fresh air throughout the interior space 12. For example, the ventilation device 32 could be a balanced system, as shown in FIG. 1A, where both outside air and indoor air are ducted from/to outside the structure. The ventilation device 32 could be a supply only system, as shown in FIG. 1B, where only outside air is ducted to the structure. The ventilation device 32 could also be an exhaust only system, as shown in FIG. 1C, where only indoor air is ducted to outside the structure.

In an embodiment, the system controller 14 may be operably coupled to one or more sensing devices 34 disposed on an access object 36. In an embodiment, the access object 36 includes at least one of a window, door, or any other opening that may allow pollutants to enter the interior space 12 from the outside. The one or more sensing devices 34 are configured to transmit an access signal based in part on the state of the access object 36 (i.e., whether the access object 36 is opened or closed.

For example, a home may have many sensing devices 34, for example sensing devices from a security system, disposed on each access object 36 that provides access to the outside. The system controller 14 may be operably coupled to each sensing device 34 to determine whether the access object 36 is left open for a period of time, and/or the number of times the access object 36 has been opened and/or closed. It will be appreciated that the system controller 14 may be operably coupled to a main access device 38, for example a main panel of a security system. The system controller 14 may receive signals from the main access device 38 designating whether the access object 36 is open and/or closed.

In some embodiments, the system controller 14 transmits signals to the HVAC unit 24 to operate in a heating, cooling, and/or fan mode to condition the interior space 12, and to operate the indoor fan assembly 28 based in part on at least one of the outside air particulate forecast received from the secondary source and the access signal received from the one or more sensing devices 34. In some embodiments, the system controller 14 may also transmit signals to operate the ventilation device 32 based in part on at least one of the outside air particulate forecast received from the secondary source and the access signal received from the one or more sensing devices 34. The HVAC unit 24 may be operated independently from or in coordination with the ventilation device 32.

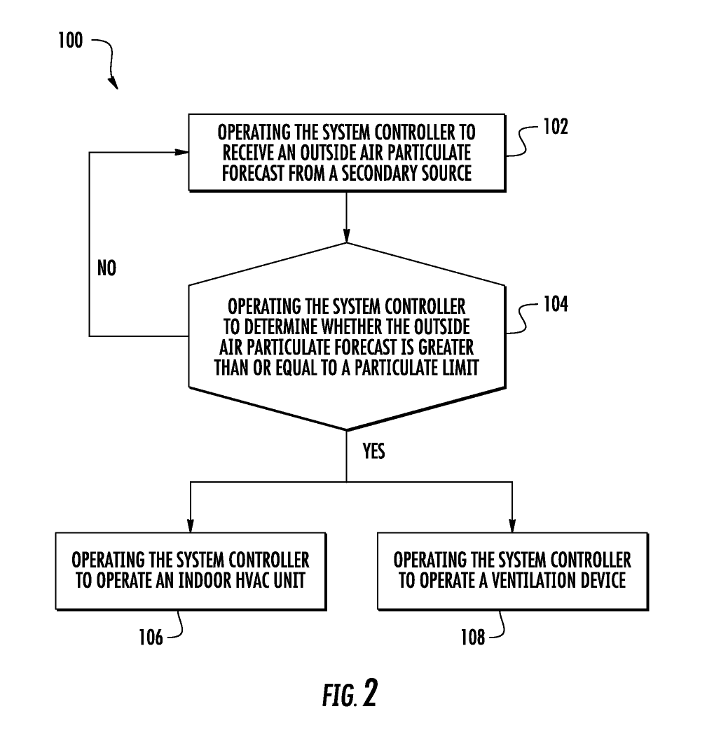

FIG. 2 illustrates a method of reducing particulate pollutants in an interior space 12, the method generally indicated at 100. The method includes step 102 of operating the system controller 14 to receive an outside air particulate forecast from a secondary source. In one embodiment, the secondary source is configured to supply up to date, but not necessarily instantaneous, outside air particulate forecast. It will be appreciated that the secondary source may include a website, or a live feed, or any other source capable of supplying up to date, but not necessarily instantaneous, outside air particulate forecast to name a few of non-limiting examples. For example, with reference to FIG. 1A, the system controller 14 operates the communication module 20 to access an external website containing outside air particulate forecast (e.g. a pollen forecast from www.pollen.com or www.wunderground.com to name a couple of non-limiting examples), or other sources, to acquire outside air particulate forecast based upon the location of the HVAC system 10.

The method 100 further includes step 104 of operating the system controller 14 to determine whether the outside air particulate forecast is greater than or equal to a particulate limit. In an embodiment, the outside air particulate forecast includes forecast of airborne pollen levels. It will be appreciated that the outside air particulate forecast may include a forecast for any outside air particle matter.

For example, a user may set a particulate limit within the system controller 14 based upon the user's tolerance and/or preference to filter particle pollutants within the interior space 12. In other embodiments, the particulate limit may be pre-determined by the manufacturer of the system controller 14. In an embodiment, the particulate limit may be a numerical representation of the pollen count forecast for a given day or period of time during a day based upon the location of the HVAC system 10. In one embodiment, the system controller 14 may focus on a particular type of particulate, such as pollen, to compare to the particulate limit. In one embodiment, the system controller 14 may create a blended or weighted average of two or more different particulate measurements to compare to the particulate limit.

In another embodiment, the particulate limit may be a text base representation (e.g., high, medium, and low to name a few non-limiting examples). For example, the outside air particulate forecast may be represented by a pollen count. A pollen count is a measure of how much pollen is in the air in a certain area at a specific time. It is expressed in grains of pollen per square meter of air collected over 24 hours. A low pollen forecast, as used by www.pollen.com, may be represented by a numerical representation between 0 and 2.4; a low-medium pollen forecast may be represented by a numerical representation between 2.5 and 4.8; a medium pollen forecast may be represented by a numerical representation between 4.9 and 7.2; a medium-high pollen forecast may be represented by a numerical representation between 7.3 and 9.6; and a high pollen forecast may be represented by a numerical representation between 9.7 and 12. The user may then select a particulate limit (e.g., 5.0) based on the user's sensitivity to a particular pollutant.

The method 100 includes step 106 of operating the HVAC unit 24 based in part on at least one of the outside air particulate forecast. In an embodiment, the system controller 14 transmits a signal to turn on the fan assembly 28 if the outside air particulate forecast is greater than or equal to the particulate limit.

Operating the fan assembly 28 functions to circulate the air within the interior space 12 through the filtration device 30 and back out through the HVAC unit 24. As air passes through the filtration device 30, particulates are captured in the filtration device 30; thus, the total amount of particulates within the interior space 12 is effectively reduced

In other embodiments, the system controller 14 may transmit one or more signals to the HVAC unit 24 to operate the fan assembly 28 at different speeds based on the outside air particulate forecast, access signals and/or the operating time of the fan assembly 28 to minimize energy consumption while effective removing pollutants within the interior space 12.

In another embodiment, the method further includes step 108 of operating the ventilation device 32 based in part on the outside air particulate forecast. In an embodiment, the system controller 14 transmits a signal to turn off the ventilation device 32 if the outside air particulate forecast is greater than or equal to the particulate limit.

For example, in the embodiment shown in FIG. 1A, if the ventilation device 32 is operating to exchange outside air with the stale air within the interior space 12, doing so may effectively increase the particulate level within the interior space 12 if the outside air particulate forecast is high for that given day or period of time. Continuing with the prior scenario where the particulate limit is set to 5.0 and the forecasted pollen level for Tuesday is 10.1, in addition to turning on the fan assembly 28, the system controller 14 transmits a signal to turn off the ventilation device 32 if the forecasted pollen level is greater than the particulate limit; thus, effectively reducing the amount of pollen that may enter the interior space 12 from the outside.

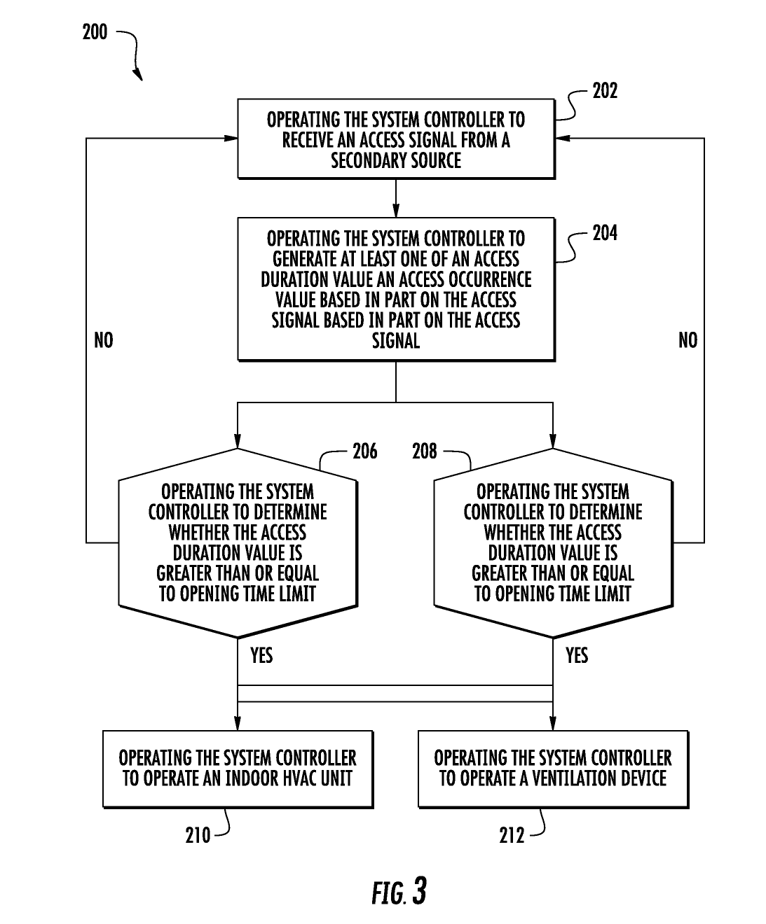

FIG. 3 illustrates another embodiment of a method to reduce particulate pollutants within a conditioned space, the method generally indicated at 200. The method includes step 202 operating the system controller 14 to receive an access signal from a secondary source. In an embodiment, the secondary source includes one or more sensing devices 34, wherein the one or more sensing devices 34 are operably coupled to an access opening 36 operably coupled to an access opening. For example, if an access object 36 is left open, the sensing device 34 will send a signal to the system controller 14 directly, or to the main access panel 38 designating the open state of access object 36.

The method 200 further includes step 204 of operating the system controller 14 to generate at least one of an access duration value an access occurrence value based in part on the access signal based in part on the access signal. For example, if an access object 36 is opened, the sensing device 34 transmits a signal to the system controller 14 designating the open state of the access object 36. The system controller 14 may begin a timer to determine the amount of time that the access object 36 is left in an open state. In one embodiment, the system controller 14 may record and sum the access duration value for each access object 36 and compare that sum to a user-selected opening duration limit. It will be appreciated that the opening duration limit may be pre-determined by the manufacturer of the system controller 14. In one embodiment, the opening duration limit may be increased when there is a low particulate forecast and decreased when there is a high particulate forecast.

In addition, or alternatively, the system controller 14 may start a counter of the number of occurrences that the access object 36 is opened within a pre-determined continuous period of time. The system controller 14 then determines whether the number of occurrences that the access object 36 is opened within a continuous period of time is greater than or equal to user-selected opening occurrence limit. In one embodiment, the system controller 14 may record and sum the opening occurrence value for each access object 36 and compare that sum to a user-selected opening occurrence limit. It will be appreciated that the opening occurrence limit may be pre-determined by the manufacturer of the system controller 14. In one embodiment, the opening occurrence limit may be increased when there is a low particulate forecast and decreased when there is a high particulate forecast.

The method 200 further includes step 206 of operating the system controller 14 to determine whether the access duration value is greater than or equal to opening duration limit. In addition, or alternatively the method includes step 208 of operating the system controller 14 to determine whether the access occurrence value is greater than or equal to opening occurrence limit.

The method 200 includes step 210 of operating the HVAC unit 24 based in part on the access signal. In an embodiment, the system controller 14 transmits a signal to turn on the fan assembly 28 if the outside air particulate forecast is greater than or equal to the particulate limit and the access duration value is greater than or equal to the opening duration limit. Additionally, or alternatively, the system controller 14 transmits a signal to turn on the fan assembly 28 if the outside air particulate forecast is greater than or equal to the particulate limit and the access occurrence value is greater than or equal to the opening occurrence limit.

For example, the system controller 14 determines whether the duration of time that the access object 36 is left open is greater than or equal to user-selected duration limit. If the access object 36 is left open and the access duration value is greater than or equal to the user-selected opening duration limit, the system controller 14 transmits a signal to turn on the fan assembly 28. In some embodiments, if the access object 36 is left open and the access duration value is greater than or equal to the user-selected opening duration limit, the system controller 14 transmits a signal to turn off the fan assembly 28 independent of the outside air particulate forecast. It will be appreciated that the opening duration limit may be pre-determined by the manufacturer of the system controller 14.

Additionally, or alternatively, the system controller 14 determines whether the number of occurrences that the access object 36 is left open is greater than or equal to user-selected opening occurrence limit. If the outside air particulate forecast is greater than or equal to the particulate limit, and an access object 36 is opened multiple times within a pre-determined continuous period of time (e.g. 1 hour) and the number of occurrences is greater than or equal to the user-selected opening occurrence limit, the system controller 14 transmits a signal to turn on the fan assembly 28. In another example, if the access object 36 (e.g. front door) is opened and closed more than a user-defined occurrence limit and the outside air particulate forecast is greater than or equal to the particulate limit, the system controller 14 transmits a signal to turn on the fan assembly 28. In some embodiments, if the access object 36 is opened multiple times within a pre-determined continuous period of time and the number of occurrences is greater than or equal to the user-selected opening occurrence limit, the system controller 14 transmits a signal to turn off the fan assembly 28 independent of the outside air particulate forecast.

Operating the fan assembly 28 functions to circulate the air within the interior space 12 through the filtration device 30 and back out through the HVAC unit 24. As air passes through the filtration device 30, particulates are captured in the filtration device 30; thus, the total amount of particulates within the interior space 12 is effectively reduced.

In other embodiments, the system controller 14 may transmit one or more signals to the HVAC unit 24 to operate the fan assembly 28 at different speeds based on the outside air particulate forecast, access signals and/or the operating time of the fan assembly 28 to minimize energy consumption while effective removing pollutants within the interior space 12.

In another embodiment, the method further includes step 212 of operating the ventilation device 32 based in part on the access signals. In an embodiment, the system controller 14 transmits a signal to turn off the ventilation device 32 if the access duration value is greater than or equal to the opening duration limit. Additionally, or alternatively, the system controller 14 transmits a signal to turn off the ventilation device 32 if the access occurrence value is greater than or equal to opening occurrence limit.

For example, in the embodiment shown in FIG. 1A, if the ventilation device 32 is operating to exchange outside air with the stale air within the interior space 12, doing so may effectively increase the particulate level within the interior space 12 if the outside air particulate forecast is high for that given day or period of time. If the outside air particulate forecast is greater than or equal to the particulate limit and an access object 36 is left open and the access duration value is greater than or equal to the user-selected opening duration limit, the system controller 14 transmits a signal to turn off the ventilation device 32. In some embodiments, if the access object 36 is left open and the access duration value is greater than or equal to the user-selected opening duration limit, the system controller 14 transmits a signal to turn off the ventilation device 32 independent of the outside air particulate forecast.

Additionally or alternatively, if the outside air particulate forecast is greater than or equal to the particulate limit and an access object 36 is opened multiple times within a pre-determined continuous period of time (e.g. 1 hour) and the number of occurrences is greater than or equal to the user-selected opening occurrence limit, the system controller 14 transmits a signal to turn off the ventilation device 32. In some embodiments, if the access object 36 is opened multiple times within a pre-determined continuous period of time and the number of occurrences is greater than or equal to the user-selected opening occurrence limit, the system controller 14 transmits a signal to turn off the ventilation device 32 independent of the outside air particulate forecast.

It will be appreciated that the system controller 14 may control the fan assembly 28 and/or the ventilation device 32 independently of any particulate matter data to reduce the amount of unconditioned air being brought into the interior space 12 unnecessarily. In some embodiments, the system controller 14 may display, or operate the communication module 20 to transmit an alert signal indicating that either the opening duration limit and/or the opening occurrence limit has been reached when the outside are particulate forecast is greater than or equal to the particulate limit to provide a notification for the user that an access object 34 may be open or has opened multiple times to ensure that the particulate removal feature is enabled.

It will therefore be appreciated that the above embodiments effectively reduce the total amount of particulate matter within the interior space 12 by turning on the fan assembly 28 and optionally turning off the ventilation device 32 when the forecasted outside air particulate levels are greater than a user-selected particulate limit, and/or the duration of time that an access object 34 is left open is greater than or equal to user-selected opening duration limit, and/or the number of occurrences an access object 36 is opened within a pre-determined duration of time is greater than or equal to the user-selected opening occurrence limit, set within the system controller 14.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method of reducing particulate pollutants within a conditioned space using a system controller, the method comprising:
(a) operating the system controller to receive at least one of an outside air particulate forecast and an access signal from at least one secondary source;
(b) operating the system controller to determine at least one of:
(i) whether the outside air particulate forecast is greater than or equal to a particulate limit;
(ii) whether an access duration value is greater than or equal to opening duration limit;
(iii) whether an access occurrence value is greater than or equal to opening occurrence limit; and
(c) operating the system controller to operate a fan assembly of an HVAC unit based in part on at least one of the outside air particulate forecast and the access signal.

2. The method of claim 1, wherein step (a) further comprises:
(i) operating the system controller to generate an access duration value based in part on the access signal; and
(ii) operating the system controller to generate an access occurrence value based in part on the access signal.

3. The method of claim 1, wherein step (c) comprises operating the system controller to transmit a signal to turn on a fan assembly if the outside air particulate forecast is greater than or equal to the particulate limit.

4. The method of claim 3, further comprising operating the system controller to transmit a signal to turn on a fan assembly if the outside air particulate forecast is greater than or equal to the particulate limit and either the access duration value is greater than or equal to opening duration limit, or access occurrence value is greater than or equal to opening occurrence limit.

5. The method of claim 1, further comprising:
(d) operating the system controller to operate a ventilation device based in part on at least one of the outside air particulate forecast and the access signal.

6. The method of claim 5, wherein step (d) comprises operating the system controller to turn off the ventilation device if the outside air particulate forecast is greater than or equal to the particulate limit.

7. The method of claim 6 further comprising operating the system controller to turn off the ventilation device if the outside air particulate forecast is greater than or equal to the particulate limit and either the access duration value is greater than or equal to opening duration limit, or access occurrence value is greater than or equal to opening occurrence limit.

8. The method of claim 1, wherein the outside air particulate forecast comprises airborne pollen levels.

9. The method of claim 1, wherein the secondary source comprises at least one of a website and at least one sensing device.

10. A method of reducing particulate pollutants within a conditioned space using a system controller, the method comprising:
(a) operating the system controller to receive an access signal from at least one sensing device;
(b) operating the system controller to determine at least one of:
(i) whether an access duration value is greater than or equal to opening duration limit; and
(ii) whether an access occurrence value is greater than or equal to opening occurrence limit; and
(c) operating the system controller to operate an HVAC unit based in part on the access signal.

11. The method of claim 10, wherein step (a) further comprises:
(i) operating the system controller to generate an access duration value based in part on the access signal; and
(ii) operating the system controller to generate an access occurrence value based in part on the access signal.

12. The method of claim 10, wherein step (c) comprises operating the system controller to transmit a signal to turn off a fan assembly if either the access duration value is greater than or equal to an opening duration limit or if the access occurrence value is greater than or equal to an opening occurrence limit.

13. The method of claim 10, further comprising:
(d) operating the system controller to operate a ventilation device based in part on the access signal.

14. The method of claim 13, wherein step (d) comprises operating the system controller to turn off the ventilation device if either the access duration value is greater than or equal to opening duration limit, or access occurrence value is greater than or equal to opening occurrence limit.

15. A method of reducing particulate pollutants within a conditioned space using a system controller, the method comprising:
(a) operating the system controller to receive an outside air particulate forecast from a secondary source;
(b) operating the system controller to determine whether the outside air particulate forecast is greater than or equal to a particulate limit; and
(c) operating the system controller to operate a fan assembly of an HVAC unit based in part on the outside air particulate forecast.

16. The method of claim 15, wherein the step (c) comprises operating the system controller to turn on the fan assembly if the outside air particulate forecast is greater than or equal to the particulate limit.

17. The method of claim 15, further comprising:
(d) operating the system controller to operate a ventilation device based in part on the outside air particulate forecast.

18. The method of claim 17, wherein step (d) comprises operating the system controller to turn off the ventilation device if the outside air particulate forecast is greater than or equal to the particulate limit.

19. An HVAC system comprising:
at least one secondary source;
a system controller in communication with the secondary source; and
an HVAC unit in communication with the system controller, the HVAC unit comprising a fan assembly configured to condition air within an interior space;
wherein the system controller is configured to:
(a) receive at least one of an outside air particulate forecast and an access signal from the secondary source;
(b) transmit a signal to operate the fan assembly based on at least one of the outside air particulate forecast and access signal.

20. The system of claim 19, wherein the at least one secondary source comprises a website.

21. The system of claim 20, wherein the website is configured to supply up to date, but not necessarily instantaneous, outside air particulate forecast.

22. The system of claim 21, wherein the outside air particulate forecast comprises airborne pollen levels.

23. The system of claim 21, wherein the system controller is further configured to:
(i) determine whether the outside air particulate forecast is greater than or equal to a particulate limit; and
(ii) transmit a signal to turn on a fan assembly if the outside air particulate forecast is greater than or equal to a particulate limit.

24. The system of claim 23, wherein the particulate limit is adjustable.

25. The system of claim 19, wherein the at least one secondary source comprises at least one sensing device configured to transmit the access signal.

26. The system of claim 23, wherein the system controller is further configured to:
(i) generate an access duration value based in part on the access signal;
(ii) generate an access occurrence value based in part on the access signal;
(iii) determine whether the access occurrence value is greater than or equal to an opening duration limit;
(iv) determine whether the access duration value is greater than or equal to an opening occurrence limit;
(v) transmit a signal to turn on a fan assembly if the outside air particulate forecast is greater than or equal to a particulate limit and either the access duration value is greater than or equal to the opening duration limit, or if the access occurrence value is greater than or equal to the opening occurrence limit.

27. The system of claim 26, wherein the opening duration limit and the opening occurrence limit are adjustable.

28. The system of claim 19 further comprising a ventilation device in air flow communication with the indoor HVAC unit, wherein the ventilation device is configured to facilitate distribution of fresh air throughout an interior space.

29. The system of claim 28, wherein the system controller is further configured to transmit a signal to operate the ventilation device based on at least one of the outside air particulate forecast and the access signal.

30. The system of claim 29, wherein the system controller is further configured to transmit a signal to turn off the ventilation device if the outside air particulate forecast is greater than or equal to a particulate limit.

31. The system of claim 30, wherein the system controller is further configured to transmit a signal to turn off the ventilation device if the outside air particulate forecast is greater than or equal to a particulate limit and either the access duration value is greater than or equal to the opening duration limit, or the access occurrence value is greater than or equal to the opening occurrence limit.

32. The system of claim 19, further comprising a filtering device in airflow communication with indoor HVAC unit, the filtering device configured to filter the air within an interior space.
